(19) United States
(12) Patent Application Publication
(10) Pub. No.: US 2019/0311439 A1
(43) Pub. Date: Oct. 10, 2019

(54) Online Networking Platform And Method Of Managing User Accounts Therein

(71) Applicants: Kenneth Quintana, Land O Lakes, FL (US); Dirk Loosen, Hollywell (AU)

(72) Inventors: Kenneth Quintana, Land O Lakes, FL (US); Dirk Loosen, Hollywell (AU)

(21) Appl. No.: 15/945,728

(22) Filed: Apr. 4, 2018

(51) Int. Cl. G06Q 50/00; H04L 12/58; H04L 29/06; H04L 29/08

(52) U.S. Cl. CPC G06Q 50/01; H04L 67/306; H04L 63/102; H04L 51/32

(57) ABSTRACT

An online networking platform is disclosed. The online networking platform includes a data network, a plurality of client devices and a network server. A processor and a computer readable memory are associated with the server. A database including a plurality of user accounts is stored in the computer readable memory. Executable software instructions are also stored in the computer memory. When executed by the processor the software instructions cause the server to perform a number of operations including receiving a link request from a first client device associated with a first user naming a second user with whom the first user desires to form a shared account. The server then sends a message to a second client device associated with the second user notifying the second user of the request. Upon receiving a response from the second client device agreeing to the creation of the shared user account, the server creates the shared user. The server enables interactions between the shared user account and user accounts associated with other users of the online social/professional networking platform. Finally, the server disables interactions between the first and second users' user accounts and other users' user accounts.

### FIELD OF THE INVENTION

The present invention relates to social/professional networking platforms that allow users to interact, on many different levels, with an extended online community. More specifically, the invention relates to the management of user accounts within such an online social/professional networking platform to allow users to link accounts so as to present themselves as a couple, or as partners, or as having some other relationship to the wider online social/professional networking platform community of users.

### BACKGROUND OF THE INVENTION

Social networking platforms such as Facebook, Snapchat and Instagram are well known in the art. Also known are professional networking platforms such as LinkedIn, and dating platforms like Tinder or Grindr. A common aspect of such online networking platforms is that the individual users communicate with one another via their personal user accounts which are created and stored within the backend systems of whichever online networking platform the user happens to be on.

A user account typically includes a user profile. The user profile includes information about the user that may be shared with the wider user community, either on an unrestricted basis, or with specific limitations imposed by the user. Many online social/professional networking platforms mine data from the user profiles of their users to identify users who may have one or more common interests. The platform may then seek to introduce various users to one another in an effort to expand their online social/professional network. If the users introduced in this manner agree, they may form connections so that it becomes easier to share messages, photos, events, and the like via the online social/professional networking platform.

A drawback to existing online social/professional networking platforms is that interacting with such platforms is generally a solo affair. Individuals each have their own user accounts. Other than the user's profile, the information in a user's user account remains private unless the user takes active steps to make it public. Moreover, most users interact with such platforms via their smartphones, tablets or laptop computers. Again, a mostly solitary endeavor. The solitary nature of interacting with existing online social/professional networking platforms makes it difficult for couples, partners, or members of other types of relationships to share their online social/professional network experience beyond simply being members of each other's social networks. A deeper, more satisfying way of combining the user experience of couples, business partners or other pairings of individuals is needed.

### SUMMARY OF THE INVENTION

According to an embodiment of the invention an online networking platform includes a data network, a plurality of client devices and a network server. The client devices are associated with a number of social/professional networking platform users. The client devices are adapted to display information to the users, receive input from the users, and to communicate with the server over the data network. Likewise, the network server is adapted to communicate with the plurality of client devices over the data network. A processor and a computer readable memory are associated with the server. A database including a plurality of user accounts, each associated with one of the plurality of users is stored in the computer readable memory. Executable software instructions are also stored in the computer memory. When executed by the processor the software instructions cause the server to perform a number of operations. First, upon receiving a link request from a first client device associated with a first user naming a second user with whom the first user desires to form a shared account, the server sends a message to a second client device associated with the second user. The message sent to the second user notifies the second user that the first user has sent a request to form a shared account. Upon receiving an affirmative response from the second client device agreeing to the creation of a shared user account with the first user, the serve creates the shared user account associated with the first user and the second user and stores the shared user account in the database. Once the shared account has been created the server enables interactions between the shared user account and the user accounts associated with other users of the online social/professional networking platform. Next, the server disables interactions between the first user's user account and the user accounts of other users of the online social/professional networking platform and between the second user's user account and the user accounts of other users of the online social/professional networking platform.

According to another embodiment of the invention a method of managing user accounts in an on-line social networking platform is provided. The method includes creating a first user account associated with a first user and a second user account associated with a second user. The first user account to include profile data related to the first user, and the second user account to include profile data related to the second user. Next, the method calls for receiving a request from the first user to create a joint account with the second user. The request is then sent to the second user, and the methods waits to receive response message from the second user agreeing to the creation of the joint account. Upon receiving the second user's agreement, the method calls for creating the joint account associated with both the first user and the second user. The joint account may include joint profile data related to both the first and second users. The method then calls for suspending the first and second user accounts while also granting access to the joint account to both the first user and the second user.

Yet another embodiment of the invention related to a network server which is adapted to communicate with a plurality of client devices over a network. The network server further adapted to receive a link request from a first client device over the network requesting to create a linked account with a second user. In response to the link request the server creates a shared user account associated with the first user and a second user. The server enables interactions between the shared user account and user accounts associated with other users, while it disables interactions between a first user account associated with the first user and user accounts associated with other users, as well as interactions between a second user account associated with the second user and user accounts associated with other users.

Finally, a method for managing user accounts on a social/professional networking platform according to the present invention is provided. The method according to this embodiment includes storing a plurality of user accounts in a database. The method further calls for receiving a link accounts request from a first client device associated with a first user of the social/professional networking platform. The link account request identifies both the first user account associated with the first user, and a second user account associated with a second user with whom the first user wishes to link accounts. Upon receiving the link accounts request the method calls for creating a shared user account associated with both the first user and the second user, and storing the shared account in the database. The first user and the second user are both allowed to access the shared user account. The shared user account is then enabled to interact with other user accounts stored in the database associated with other user of the online social/professional networking platform while the first and second user accounts associated with the first and second users are disabled from interacting with the other user accounts.

### BRIEF DESCRIPTION OF THE DRAWINGS

FIG. 1 is an illustrations of an on-line social/professional networking platform according to an embodiment of the invention;

FIG. 2 is a representation of a sample user account for an online social/professional networking platform;

FIG. 3 is an illustration of the logical process of creating a shared user account according to an embodiment of the invention;

FIG. 4 is an illustration of the logical process of de-linking two users from a shared user account according to an embodiment of the invention;

FIG. 5 is a flow chart describing the steps of creating a shared user account according to an embodiment of the invention; and

FIG. 6 is a flow chart describing the steps of de-linking two users from a shared user account according to an embodiment of the invention.

### DETAILED DESCRIPTION OF THE INVENTION

The present invention relates to online social/professional networking platforms. According to an embodiment of the invention an online social/professional networking platform facilitates interactions among and between users, allowing users to form connections and have relationships with other users who, but for an introduction via the online social/professional networking platform, may never have met.

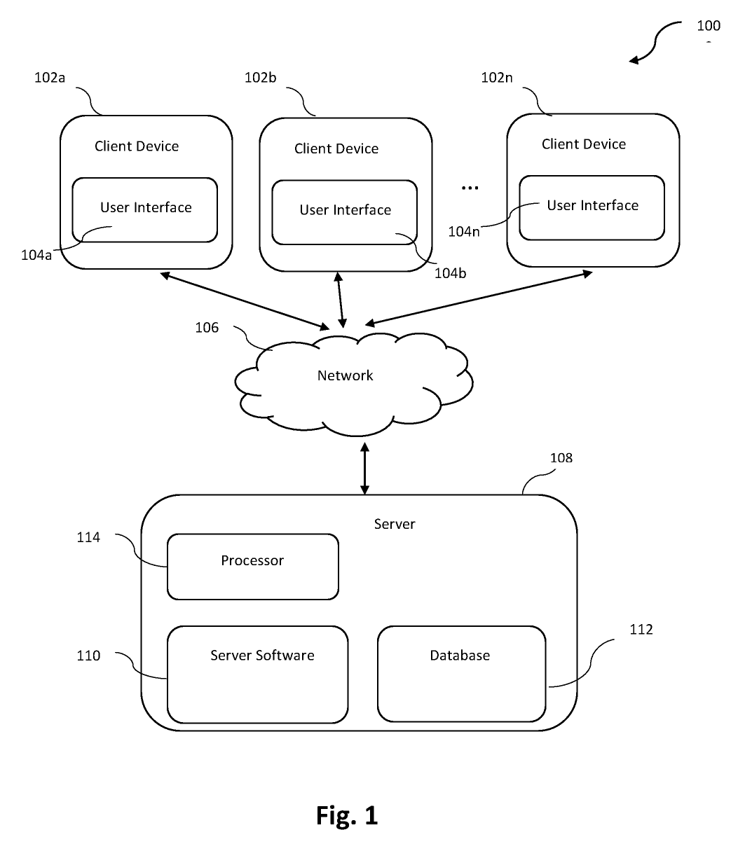

The basic architecture of an online social/professional networking platform according to the present invention is shown in FIG. 1. An online social/professional networking platform 100 includes a number of client devices 102a, 102b, . . . , 102n, a communication network 106, and a network server 108. The client devices 102 may comprise smartphones, smart watches, tablet computers, laptop computers or any other personal electronic devices capable of storing and executing an online social/professional networking platform user interface application, receiving data from an online social/professional networking platform server over a network, displaying such data to a user, and receiving commands and messages from the user and communicating such instructions and messages to a network server. Each client device 102a, 102b, . . . , 102n stores and executes a corresponding user interface application 104a, 104b, . . . , 104n that allows the users associated with each of the client devices 102a, 102b, . . . , 102n to interact with the online social/professional networking platform 100.

The network server 108 may be a stand-alone computer executing social/professional networking platform server software 110, or the server 108 may be a cloud based or scalable network based platform. The server may include a processor 114 and a memory 116 for storing the software instructions that may be executed by the processor 114 to perform the functions of the online social/professional networking platform as described herein. The server 108 may further include a database 112 stored in the memory 116 or in a separate memory associated with the server 108. The database 112 is provided for, among other things, storing the user accounts of the population of users who have signed on to use the online social/professional networking platform 100.

The user interface application 104 stored and executed on each client device 102 is an application that may be downloaded from the server 108 over the network 106, or may be distributed to individual users from some other source such as an online application marketplace or the like. Once installed on a client device 102 the user interface application 104 generates a plurality of interactive screens for displaying information to the user and for receiving the user's input commands, allowing the user to interact with the platform. The user interface application is adapted to send and receive data from the server 108 over the network 106. The user interface is further adapted to display the data received from the server 108 on the various interface pages generated by the user interface application 104. Conversely, the interface application is also adapted to communicate user commands and data input via the user's interactions with the user interface application 104 to the network server 108 over the network 106. The server 108 may then execute the user commands and/or store the user supplied data in the database 112.

The network 106 may be any type of network or combination of networks allowing the server to communicate with a plurality of mobile and/or stationary client devices. For example, the network 106 may comprise any combination of a public switched telephone network, a mobile communications network, a wifi-network, a data network such as a local area network (LAN), a wide area network (WAN), a packet switched network such as the internet, or any other data communication network know to those skilled in the art.

Generally speaking, the purpose of online social/professional networking platforms is to introduce people who have some shared trait or common interest and to facilitate communication between them. An advantage of such platforms is that, with an extremely large universe of users, such platforms can discover similarities and shared interests among users who, in all likelihood, would otherwise never meet. According to an embodiment of the invention, each user of the online social/professional networking platform is represented by a user account. Each user's user account is stored in the database 112. A user's user account determines the information that is communicated to the user's client device 102 for display by the client device's corresponding user interface application 104 as well as the information about the user which is shared with other users. Moreover, individual users of the social/professional networking platform do not communicate directly with one another, but rather users communicate with their corresponding user account, and each user's user account communicates with other users' user accounts. Based on various user selected settings stored within a user's user account, a user can control which information and messages are presented to the user via the interface application 104, as well as what information about the user is presented to other users, and to which other users it is presented.

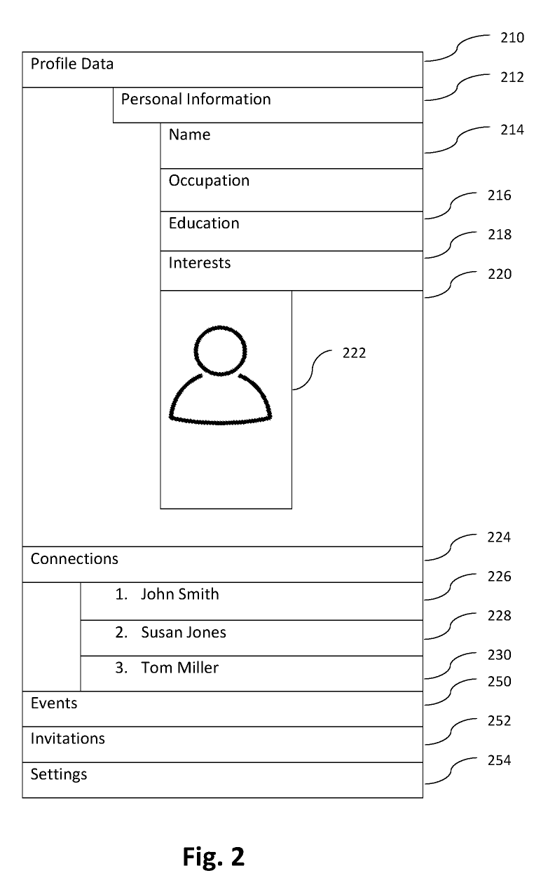

A user account is a logical construct that may be represented as one or more tables stored in the database 112. FIG. 2 shows a representation of a user account record that includes exemplary information that may be included in user's user account according to an embodiment of the invention. The user account record 200 includes an account name 202, and login credentials 204. As is well known in the art, a user attempting to access a particular account in an online social/professional networking platform 100 may be required to prove his or her identity by entering the appropriate login credentials to gain access to any information stored in the account. The login credentials may include, for example, a username 206 and password 208, or some other information for verifying the user's identity.

The user account 200 further includes profile data 210. The profile data 210 comprises information about the user himself or herself, which the user has determined may be shared with other users regardless of whether the user has previously established a connection with the other users or not. By way of example, a user's profile data 210 may include personal information 212 such as the user's name 214, occupation 216, educational background 220, interests 222, and so forth. Of course, the particular personal information the user will wish to store, and which may be stored within the user's profile will vary depending on the purpose of the particular online social/professional networking platform to which the user belongs. For example, the personal information appropriate to a professional networking platform will differ from that appropriate to a family and friends oriented networking platform, which will in turn differ from the personal information appropriate to a dating or hook-up oriented networking platform. A user's profile data may also include a photo of the user that the user wishes to share with the broader networking platform community.

Additional data associated with a user account stored in the database 112 may include a list of “connections” 226—those other users with whom the user has established an online relationship through the platform; the contents of chat messages the user has exchanged with such connections; a list of events 250 and details about the events that the user has planned or that other users have planned and which the user plans to attend, invitations 252 to events the user has sent to other users, and invitations 264 to events that user has received from other users. Finally, the user account may include settings 254 that establish various user selectable guidelines regarding how the user wished to interact with the online social/professional networking platform.

The settings portion 270 of the user account may include user selectable controls that determine how the user wishes to interact with the online social/professional networking platform. For example, the settings may include a geographical limitation as to the location of other users the user wishes to connect with, their gender, their age, their profession, or any other classifications or restrictions appropriate to the purpose of the online social/professional networking platform.

In operation, the network server 108 of the online social/professional networking platform of the present invention scans the database 112 to find other users (potential connections) whose profile information meet various selection criteria established by the user and stored in the user's account settings. The server curates a list of potential connection and forwards profile information about each potential connections to the user's client device 102. Likewise, the network server 108 forwards profile information about the user to the client devices 102 associated with each of the potential connections. The user may browse the profile information of the potential connections via the user interface application 104 running on the user's client device 102. In browse mode the user interface sequentially displays the profile information associated with the various potential connections. While the profile information of a particular potential connection is displayed, the user may choose to accept or reject the potential connection. The user's acceptance or rejection of the potential connection is communicated to the server 108 over the network 106, where the user's decision relative to the potential connection is noted in the user's account data. As noted above, the exchange of profile information between the user and a potential connection is bi-directional. While the user is considering a potential connection's profile information, the potential connection may likewise consider the user's profile information in his or her own right on his or her own client device 102. The potential connection may also choose to either accept or reject a connection with the user. Again, the potential connection's decision is communicated to the network server 108 via the network 106, where it is noted in the potential connection's user account data. If either the user or the potential connection rejects the other, the relationship is advanced no further. If, however, both the user and the potential connection accepts the other, a connection is established between the two, opening a communication channel between the two. The connection is noted in the account data of each respective user.

It should be noted that the above description of establishing a connection between users is exemplary only. Other methods for establishing connections between users on an online social/professional networking platform may be practiced without deviating from the invention concepts of the present invention.

The communication channel created between a first user and a second user who have both agreed to a connection allows the first and second users to exchange chat messages in substantially real-time if both happen to be online at the same time, or to send text messages that may be read and replied to at each user's convenience if they are not. Connected users may invite one another to real world events and otherwise interact with one another on any other level they see fit.

In typical online social/professional networking platforms, a user account is associated with one particular individual or organization. The individual or organization that created the account is solely responsible for entering the settings governing the account, the managing the connections established with other users, the messages exchanged with other users, the events to which other users are invited and the invitations from other users that are accepted, and so forth. Moreover, the sole user or organization that established the account is solely responsible for determining what information associated with the account is made public and which is kept private. Access to the user's account information is limited to the user himself or herself while logged into the platform 100.

There are occasions, however, when it may be desirable for more than one person to have access to the user account information of a user of an online social/professional networking platform. For example, two independent professionals, each having an extensive collection of contacts and connections on a particular professional networking site, may wish to form a partnership. In addition to merging their professional enterprises they may wish to merge their online presence, including combining their accounts on the professional networking platform on which they both participate. Similarly, two individuals participating on an online social networking platform may become romantically or otherwise involved and may wish to present themselves to the online community a couple. An online social/professional networking platform according to an embodiment of the present invention can accommodate the wishes of such users through the creation of a shared or “couple” account. Hereinafter a merged account will be referred to as simply a shared account, with the understanding that the participants in such an account may have any number of different kinds of relationships.

According to an embodiment of the invention a shared account may be created between users who have already formed a connection via the online social/professional networking platform. The interface application 104 includes a user selectable option to create a shared account. When a first user selects this option the interface application presents a field into which the user may enter the username, email address, or some other information identifying the second user with whom the first user wishes to form shared account. This information is transmitted from the first user's client device 102a to the server 108 via the network 106. Upon receiving the first user's request to form a shared account, the server 108 sends a message to the second user's client device 102b via the network 106, indicating that the first user has requested to form a shared account with the second user. As an additional level of security, the server 108 may also generate an email message that is sent to an email address stored in the second user's user account. This email may include a security code that the second user may enter in a corresponding input field displayed by the interface application 104b running on the second user's client device 102b. By entering the security code in the appropriate input field, the second user assents to the creation of the shared account. Once both parties have agreed to the creation of the shared account, the server creates the shared account as described below.

The above described steps for obtaining both users' assent to the creation of a shared account are exemplary only. Other processes and methods for gaining both parties agreement to form shared account may be implemented without deviating from the inventive concept of an online social/professional networking platform of the present invention.

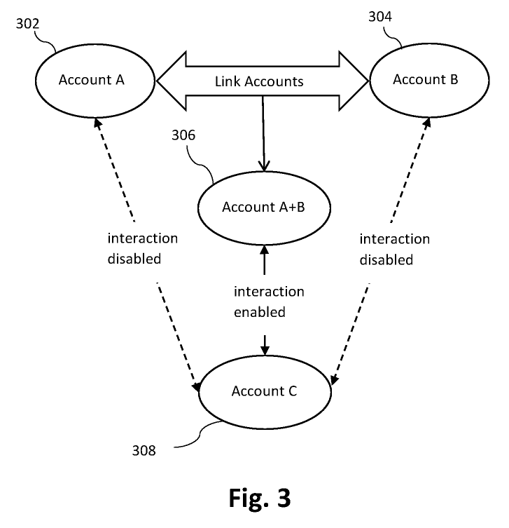

Turning now to FIGS. 1 and 3, a logical representation of the formation of a shared account according to an embodiment of the present invention is shown in FIG. 3. Account A 302, associated with a first user, is to be linked to Account B 304, associated with a second user. Once the server has received the assent of both users, the online social/professional networking platform software creates a wholly new account, Shared Account A+B 306, and stores the new account in the database 112. The new shared account functions just as any other user account except that it is associated with and accessible by, both the first user and the second user. Shared Account A+B includes a user profile that may be edited individually or jointly by both the first user and the second user. Upon creation of the Shared Account A+B, individual user Account A 302 and individual user Account B 304 are suspended. Interactions between user Account A 302 and third party accounts such as Account C 308 are disabled. When either the first user or the second user logs into the online social/professional networking platform, they are granted access to Shared Account A+B 306 only. Both users can alter the settings in shared account A+B 306, browse potential connections, create new connections, communicate and interact with connections, schedule events, invite others to events, accept invitations to other user's events, and so forth. In short, both the first user and the second user can interact with the shared account A+B 306 just as if it were their own individual account, except that all of their interactions will be transparent to the other user. Thus, for example if the first and second users happen to be a couple seeking connections with other couples to expand their social circle, the couple can jointly peruse potential connections, each using their own smartphone or other network enabled client device. Each partner can make decisions as to who to connect with and there choices will be visible to their partner substantially immediately. Similarly, if one of the users communicates with any of their joint connections, the communications will likewise be visible to the other, creating a whole new level of transparency between the couple.

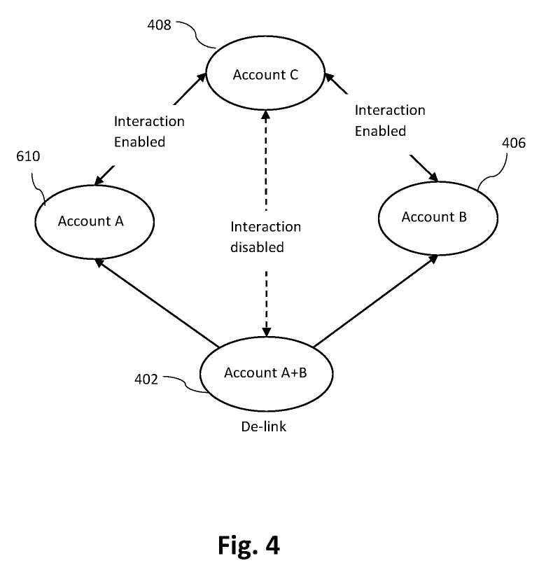

A difficulty with relationships, be they romantic relationships, friendships or business partnerships, is that they sometimes end. There may come a time when two users of the online social/professional networking platform herein described who have linked up and formed a shared account such as Shared Account A+B 304, may at some point wish to disentangle their online presence from one another. The online social/professional networking platform of the present invention accommodates linked users' desire to de-couple from one another as shown in FIG. 4. Account A+B 402 is a shared account held jointly by first user A and second user B. The shared Account A+B has a connection with Account C associated with a third party user. When a user is a participant in a shared account such as Shared Account A+B 404, the user interface application 104 executed on the user's client device displays a de-linking option. If either user party to a shared account selects the delink option, a message to that effect is sent from the corresponding device 102 to the online social/professional networking platform server 108, and the online social/professional networking platform software 110 executed by the network server 108 initiates the de-linking process. First, the Shared Account A+B is suspended. All interactions between Shared Account A+B 402 and third party user accounts, such as Account C 408, are disabled. Account A 404 associated with the first user is re-enabled, with login control returned exclusively to the first user. Interactions between Account A and third party accounts such as Account C 408 are re-enabled. Likewise, Account B 406 associated with the second user is also re-enabled, with login control returned exclusively to the second user. Interactions between Account B and third part user accounts such as Account C 408 are re-enabled. All aspects of Accounts A and B, including settings, connections, events, chats and so forth, are returned to the status quo ante. Both the first and second user may carry on using their user accounts as if the Shared Account A+B had never been entered into.

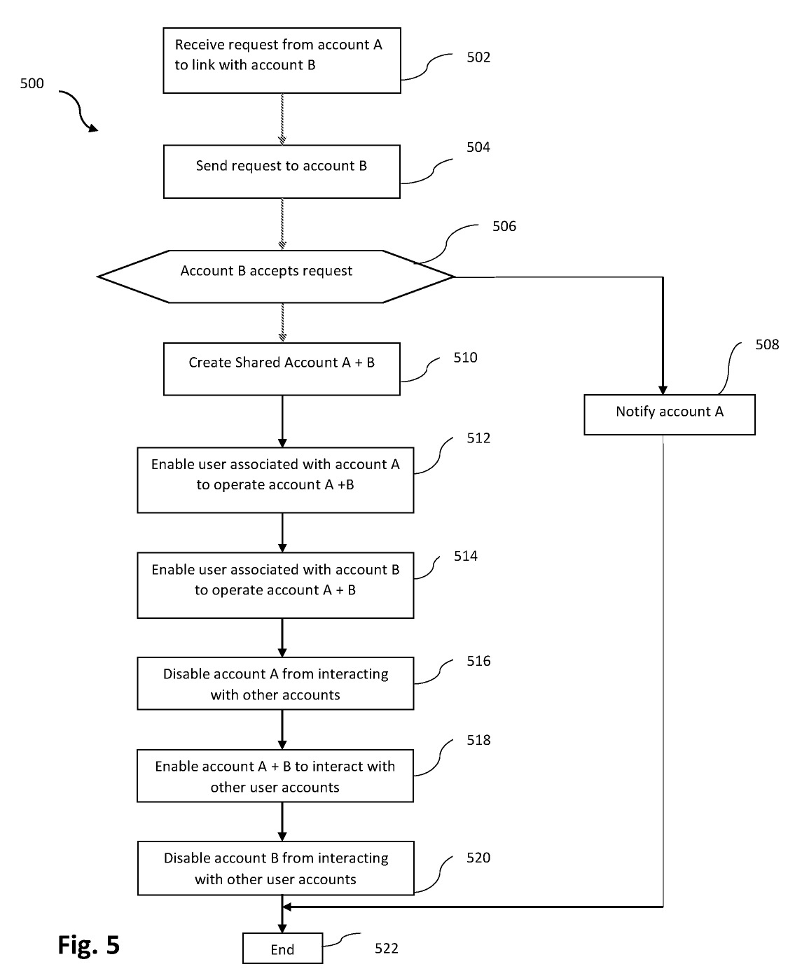

FIG. 5 shows a method 500 for linking user accounts in an online social/professional networking platform according to an embodiment of the present invention. The method begins at step 502 when the online social/professional networking platform receives a request from a user associated with a first account, Account A, to link with a second account, Account B. At step 504 the online social/professional networking platform forwards the request to the user associated with Account B. At Decision block 506 the user associated with Account B may choose to accept or reject the request to link Accounts. If the user associated with Account B rejects the request, the online social/professional networking platform notifies the user associated with Account A at step 508 of the rejection, and the precessends at step 522. If, however, the user associated with Account B chooses to accept the request to link accounts, the process proceeds to step 510 where the online social/professional networking platform creates Shared Account A+B. At step 512 the online social/professional networking platform enables the user associated with Account A to operate Shared Account A+B, and at step 514 enables the user associated with Account B to operate Shared Account A+B. At step 516 the online social/professional networking platform enables the Shared Account A+B to interact with accounts associated with third party users. At step 518 the online social/professional networking platform disables Account A associated with the first user, from interacting with accounts associated with third party users, and at step 520 disables Account B associated with the second user, from interacting with accounts associated with third party users.

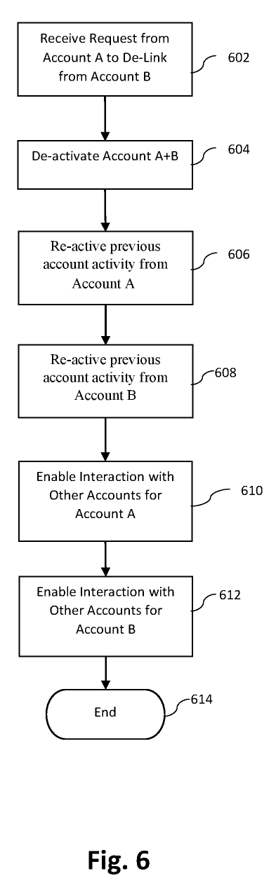

FIG. 6 show a process 600 for de-linking users from a shared user account in an online social/professional networking platform according to and embodiment of the invention. The de-linking process 600 begins at step 602 where the online social/professional networking platform receives a request from a first user associated with Account A, who is a party to the Shared Account A+B, to de-link Account A from the Shared Account A+B. The online social/professional networking platform reactivates Account A associated with the first user at step 606, and re-activates Account B associated with the second user at step 608. Both Account A, and Account B are reactivated in the same state—with the same settings, connections, events, invitations—as when the accounts were suspended. At step 610 the online social/professional networking platform re-enables interactions between Account A and other accounts associated with third party users, such as Account C. Similarly, at step 612 the online social/professional networking platform re-enables interactions between Account B and other accounts associated with third party users such as Account C. The process ends at step 614.

Various embodiments of the invention have been described and illustrated; however, the description and illustrations are by way of example only. Other embodiments and implementations are possible within the scope of the invention and will be apparent to those of ordinary skill in the art. Therefore, the invention is not limited to the specific details of the representative embodiments and illustrated examples in this description. Accordingly, the invention is not to be restricted except as necessitated by the accompanying claims and their equivalents.

What is claimed is:

1. A method of managing user accounts in an on-line social networking platform, the method comprising the steps of:
creating a first user account associated with a first user, the first user account including profile data related to the first user;
creating a second user account associated with a second user, the second user account including profile data related to the second user;
receiving a request from the first user to create a joint account with the second user;
communicating the request to the second user;
receiving a message from the second user agreeing to the creation of the joint account;
creating a joint account associated with the first and second user, the joint account including joint profile data related to both the first and second users;
suspending the first and second user accounts; and
granting access to the joint account to both the first user and the second user.

2. The method claim 1 further including the step of receiving a request from one of the first and second users to suspend the joint account, suspending the joint account in response to the request, and reactivating the first and second user accounts.

3. An online networking platform comprising:
a data network;
a plurality of client devices associated with a plurality of platform users, the client devices adapted to display information to the users, receive input from the users, and to communicate over the data network;
a network server adapted to communicate with the plurality of client devices over the data network;
a processor associated with the network server;
computer readable memory associated with the network server;
a database stored in the computer readable memory, the database including a plurality of user accounts associated with the plurality of users;
executable instructions stored in the computer memory, which when executed by the processor cause the server to perform operations including: upon receiving a link request from a first client device among said plurality of client devices, the first client device being associated with a first user among said plurality of platform users, the link request requesting to link accounts with a second user among said plurality of platform users, sending a message to a second client device associated with the second user, the message notifying the second user of the request;
upon receiving an affirmative response from the second client device agreeing to the creation of a shared user account with the first user, creating a shared user account associated with the first user and the second user and storing the shared user account in the database;
enabling interactions between the shared user account and user accounts associated with other users among said plurality of platform users stored in the database;
disabling interactions between a first user account associated with the first user and other user accounts associated with other users among said plurality of platform users; and
disabling interactions between a second user account associated with the second user and other user accounts associated with other users among said plurality of platform users.

4. The networking platform of claim 7 wherein specific user accounts associated with specific users stored in the database include information identifying connections made between the specific users with whom the user accounts are associated and other users of the online networking platform.

5. The online networking platform of claim 4 wherein the information identifying connections made between the specific users with whom the user accounts are associated and other users of the online networking platform includes messages exchanged between the specific users and the other users.

6. The networking platform of claim 3 wherein specific user accounts associated with specific users of the networking platform stored in the database include user editable profile information about the specific user with whom the specific user account is associated, and which may be shared with other users associated with other user accounts.

7. The networking platform of claim 3 wherein specific user accounts associated with specific users of the networking platform stored in the database include user selectable setting that govern the networking platform's interactions with the specific users associated with the specific accounts.

8. The networking platform of claim 3 wherein specific user accounts associated with specific users of the networking platform stored in the database include at least one of everts scheduled with other users, invitations to events sent to other users, and invitations to events received frothier users.

9. The networking platform of claim 3 wherein the executable instructions stored in the computer memory, when executed by the processor, cause the server to perform further operations, including:
upon receiving a de-link request from one of the first and second client devices associated with the first and second user, respectively, disabling interactions between the shared user account and user accounts associated with other users;
re-enabling interactions between the first user account associated with the first user and user accounts associated with other users; and
re-enabling interactions between the second user account associated with the second user and user accounts associated with other users.

10. A network server adapted to communicate with a plurality of client devices over a network, the server adapted to:
receive a link request from a first client device over the network;
create a shared user account associated with the first user and a second user;
enable interactions between the shared user account and user accounts associated with other users;
disable interactions between a first user account associated with the first user and user accounts associated with other users; and
disable interactions between a second user account associated with the second user and user accounts associated with other users.

11. The network server of claim 10 further adapted to:
sending a link request to a second client device over the network; and
receiving an affirmative response to the link request from the second client device prior to creating the shared user account and disabling interactions between the first and second user accounts and user accounts associated with other users.

12. The network server of claim 10 further adapted to:
receive a delink request from a client device associated with one of the first user and the second user;
disable interactions between the shared user account associated with the first user and the second user and user accounts associated with other users;
re-enable interactions between the first user account associated with the first user and user accounts associated with other users; and
re-enable interactions between the second user account associated with the second user and user accounts associated with other users.

13. A method for managing user accounts on a social/professional networking platform, the method comprising the steps of:
storing a plurality of user accounts in a database;
receiving a link account request from a first client device associated with a first user of the social/professional networking platform, the link account request identifying a first user account associated with the first user, and a second user account associated with a second user of the online social/professional networking platform;
creating a shared user account associated with both the first user and the second user, and storing the shared account in the database;
allowing the first user and the second user to access the shared user account;
enabling the shared user account to interact with other user accounts stored in the database associated with other user of the online social/professional networking platform; and
disabling the first and second user accounts from interacting with the other user accounts.

14. The network server of claim 13 further comprising the steps of:
sending a link request to a second client device over the network; and
receiving an affirmative response to the link request from the second client device prior to creating the shared user account and disabling interactions between the first and second user accounts and user accounts associated with other users.

15. The network server of claim 10 further comprising the steps of:
receiving a delink request from a client device associated with one of the first user and the second user;
disabling interactions between the shared user account associated with the first user and the second user and user accounts associated with other users;
re-enabling interactions between the first user account associated with the first user and user accounts associated with other users; and
re-enabling interactions between the second user account associated with the second user and user accounts associated with other users.
